(19) United States
(12) Patent Application Publication
(10) Pub. No.: US 2021/0266367 A1
(43) Pub. Date: Aug. 26, 2021

(54) SERVER DEVICE USED IN DISTRIBUTED PROCESSING SYSTEM, DISTRIBUTED PROCESSING METHOD, AND PROGRAM

(71) Applicant: Nippon Telegraph and Telephone Corporation, Tokyo (JP)

(72) Inventors: Misao KATAOKA, Tokyo (JP); Mitsuhiro OKAMOTO, Tokyo (JP); Masashi KANEKO, Tokyo (JP)

(21) Appl. No.: 17/253,719

(22) PCT Filed: Jun. 19, 2019
(86) PCT No.: PCT/JP2019/024305

§ 371 Date: Dec. 18, 2020

(30) Foreign Application Priority Data
Jun. 21, 2018 (JP) 2018-117605

(51) Int. Cl. H04L 29/08

(52) U.S. Cl. CPC H04L 67/148; H04L 67/34; H04L 67/26; H04L 67/1095

(57) ABSTRACT

[Problem] To provide a server apparatus, a distributed processing method, and a program used in a distributed processing system that reduces an increase in a D plane disconnection time due to an application activation delay an application of a distributed processing technology of a system in which a C plane and the D plane are integrated.

[Solution] A server apparatus 30 used in a distributed processing system 1 includes a switching completion receiving unit 334 adapted to receive a completion notification of takeover processing of middleware from a transfer source to a transfer destination and an application stop processing determination unit 333 adapted to cause application processing at the transfer source to be continued until the completion notification is received.

### TECHNICAL FIELD

The present invention relates to a server apparatus used in a distributed processing system, a distributed processing method, and a program.

### BACKGROUND ART

Performing a distributed processing technique for the purpose of implementing scale-out and improving availability has attracted attention.

OpenFlow is configured of an OpenFlow controller and OpenFlow switches. The OpenFlow controller can collectively manage operations of a plurality of OpenFlow switches. A “Control Plane” (C plane) is in charge of a path control function while a “Data Plane” (D plane) is in charge of a data transfer function.

A distributed processing technology for a communication system has mainly be applied to the C plane. On the other hand, occurrence of disconnection of the D plane may greatly affect system quality in some cases. For example, a telephone conference system transfers data such as voice and movies using a real time transport protocol (RTP) or the like. An increase in a D plane disconnection time greatly affects quality of the telephone conference system.

FIG. 12 is a functional block diagram schematically illustrating a distributed processing system in the related art.

As illustrated in FIG. 12, a distributed processing system 1 is configured to include a telephone terminal (SIP user agent) (user terminal apparatus) 2, a load balancer (LB) 3, a cluster member 4 having a conference server 4a, and a cluster member 5 having a replicated conference server 5a. The telephone terminal 2 is adapted such that interactions are performed between the cluster member 4 and the cluster member 5 with the load balancer 3 interposed therebetween using a session initial protocol (SIP). The telephone terminal 2 performs interactions directly with the cluster member 4 and the cluster member 5 using an RTP. The telephone terminal 2 performs interactions using the SIP, thereby preventing an RTP processing delay and an increase in processing in the system.

In the related art, a distributed processing system configured such that call signals are processed in a distributed manner by a plurality of server apparatuses assumes that a functional unit in middleware holds information related to the call signals. (see Patent Literature 1). In other words, statuses of call processing are not held by an application and are held in the middleware. Operations performed at the time of removal in such a distributed processing system in the related art are as follows. The distributed processing system is adapted such that processing status data held by the server apparatus is created as a replication in another server apparatus, and when a removal instruction is issued, the replication is promoted to a master, and processing is dispatched to another server apparatus, thereby enabling continuation of the processing.

Patent Literature 1 describes a data migration processing system adapted such that any of a plurality of nodes configuring a cluster are assigned as an owner node to store data for providing services to clients as master data or one or more replication nodes to store replicated data of the data.

Patent Literature 2 describes a service providing system that has a plurality of first servers adapted to transmit and receive data configuring a session to and from counterpart apparatuses via a network through distributed processing and provide services based on a predetermined file and a plurality of second servers adapted such that in a case in which a new file that is a file obtained by updating the predetermined file is acquired, the second servers provide the service based on the new file in place of the plurality of first servers.

An application has a state, and the state is not taken over through distributed processing and is generated by another means (such as using information in a database at a different location, for example).

A state of middleware is periodically taken over. The state of middleware is taken over when master transfer occurs in response to a maintenance command as well.

### CITATION LIST

### Patent Literature

Patent Literature 1: Japanese Unexamined Patent Application Publication No. 2014-41550

Patent Literature 2: Japanese Unexamined Patent Application Publication No. 2011-96161

### SUMMARY OF THE INVENTION

### Technical Problem

However, because the state of the application is not taken over through distributed processing and is generated using information in a database at a different location, for example, there is a problem that a D plane disconnection time due to a delay in activation of the application increases.

The present invention was made in view of such a background, and an object of the present invention is to provide a server apparatus, a distributed processing method, and a program used in a distributed processing system adapted to reduce an increase in D plane disconnection time due to a delay in activation of an application for an application of a distributed processing technology for a system in which a C plane and a D plane are integrated.

### Means for Solving the Problem

In order to solve the aforementioned problem, the invention according to claim 1 provides a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, the server apparatus including: a completion notification receiving section adapted to receive a completion notification of takeover processing to the other server apparatus of the middleware; and an application stop determination section adapted to cause the application processing of the server apparatus to be continued until the completion notification is received.

Also, the invention according to claim 5 provides a distributed processing method performed by a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, the method including, at the server apparatus: receiving a completion notification of takeover processing to the other server apparatus of the middleware; and causing the application processing of the server apparatus to be continued until the completion notification is received.

In addition, the invention according to claim 7 is a program that causes a computer, which serves as a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, to function as a completion notification receiving section adapted to receive a completion notification of takeover processing to the other server apparatus of the middleware; and an application stop determination section adapted to cause the application processing of the server apparatus to be continued until the completion notification is received.

This enables an application end time to be delayed such that the application can be ended before transfer after activation of the application is completed at the transfer destination. It is thus possible for a current processing to be continued without being disconnected in a case in which a server apparatus is removed from the distributed processing system. For example, because the D plane performs interactions directly with a telephone, it is possible to continue to talk unless the application ends. Also, only substantially instantaneous disconnection occurs in a talk interruption time. As a result, it is possible to reduce an increase in D plane disconnection time due to a delay in activation of the application, which is caused because the state of the application is not taken over, in the application of the distributed processing technology for the system in which the C plane and the D plane are integrated.

In this manner, it is possible to reduce a switching time in a case in which an application in which both middleware and the application have a state is applied to a distributed processing infrastructure.

Also, the invention according to claim 3 provides a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, the server apparatus including: an application start processing section adapted to bring the application at a transfer destination into an active standby status in which the application is activated in advance when the replication of the middleware is created.

Also, the invention according to claim 6 provides a distributed processing method performed by a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, the method including, at the server apparatus: bringing the application at a transfer destination to be in an active standby status in which the application is activated in advance when the replication of the middleware is created.

Also, the invention according to claim 8 provides a program that causes a computer, which serves as a server apparatus used in a distributed processing system configured such that processing status data of middleware held by the server apparatus is created as a replication in another server apparatus, the replication is promoted to a master when removal of the server apparatus is carried out, and processing is dispatched to the other server apparatus, thereby continuing processing of the middleware and an application, to function as: an application start processing section adapted to bring the application at a transfer destination into an active standby status in which the application is activated in advance when the replication of the middleware is created.

This enables an increase in switching time due to a delay in activation of the application to be prevented by activating the application as the replication that serves as the transfer destination in advance when the replication is created. It is possible to reduce an increase in a D plane disconnection time due to a delay in activation of the application, which is caused because the state of the application is not taken over, in an application of the distributed processing technology for the system in which the C plane and the D plane are integrated.

It is also possible to reduce a switching time at the time of breakdown as well.

In this manner, it is possible to reduce a switching time in a case in which an application in which both middleware and the application have a state is applied to a distributed processing infrastructure.

Also, the invention according to claim 2 is the server apparatus according to claim 1, in which the application stop determination section ends an application process of the server apparatus after the takeover processing to the other server apparatus of the middleware and processing of initializing the application at a transfer destination.

This enables an application end time to be delayed such that the application can be ended before transfer after activation of the application is completed at the transfer destination, by providing a completion notification of switching from the application at the transfer destination to the application after the transfer.

Also, the invention according to claim 4 is the server apparatus according to claim 3, in which the application start processing section performs the takeover processing to the other server apparatus of the middleware and processing of switching a service after an application process of the server apparatus ends.

This enables the application at the transfer destination to be kept in the active state by performing the takeover processing of the middleware from the transfer source to the transfer destination and the processing of switching the service after the application process at the transfer source ends.

### Effects of the Invention

According to the present invention, it is possible to provide a server apparatus, a distributed processing method, and a program used in a distributed processing system adapted to reduce an increase in D plane disconnection time due to a delay in activation of an application for an application of a distributed processing technology for a system in which a C plane and a D plane are integrated.

### BRIEF DESCRIPTION OF DRAWINGS

FIG. 1 is a functional block diagram schematically illustrating a distributed processing system according to a first embodiment of the present invention.

FIG. 2 is a functional block diagram of application units and middleware units of a pre-transfer cluster member and a post-transfer cluster member of a server apparatus in the distributed processing system according to the aforementioned first embodiment.

FIG. 3 is a flowchart illustrating a master process stop delay determination based on middle state takeover completion notification, which is executed by the middleware unit of the pre-transfer cluster member of the server apparatus in the distributed processing system according to the aforementioned first embodiment.

FIG. 4 is a flowchart illustrating a master process stop delay determination based on a switching completion notification, which is executed by the middleware unit of the pre-transfer cluster member of the server apparatus in the distributed processing system according to the aforementioned first embodiment.

FIG. 5 is a control sequence diagram illustrating operations at the time of a maintenance command of a distributed processing system according to a comparative example to be compared with the aforementioned first embodiment.

FIG. 6 is a control sequence diagram illustrating operations at the time of a maintenance command of the server apparatus in the distributed processing system according to the aforementioned first embodiment.

FIG. 7 is a functional block diagram of application units and middleware units of a pre-transfer cluster member and a post-transfer cluster member in a distributed processing system according to a second embodiment of the present invention.

FIG. 8 is a flowchart illustrating replicated application start determination, which is executed by the middleware unit of the post-transfer cluster member of the server apparatus in the distributed processing system according to the aforementioned second embodiment.

FIG. 9 is a control sequence diagram illustrating operations at the time of a maintenance command of the server apparatus in the distributed processing system according to the aforementioned second embodiment.

FIG. 10 is a control sequence diagram illustrating operations at the time of breakdown of a distributed processing system according to a comparative example to be compared with the aforementioned second embodiment.

FIG. 11 is a control sequence diagram illustrating operations at the time of breakdown of the server apparatus in the distributed processing system according to the aforementioned second embodiment.

FIG. 12 is a functional block diagram schematically illustrating a distributed processing system in the related art.

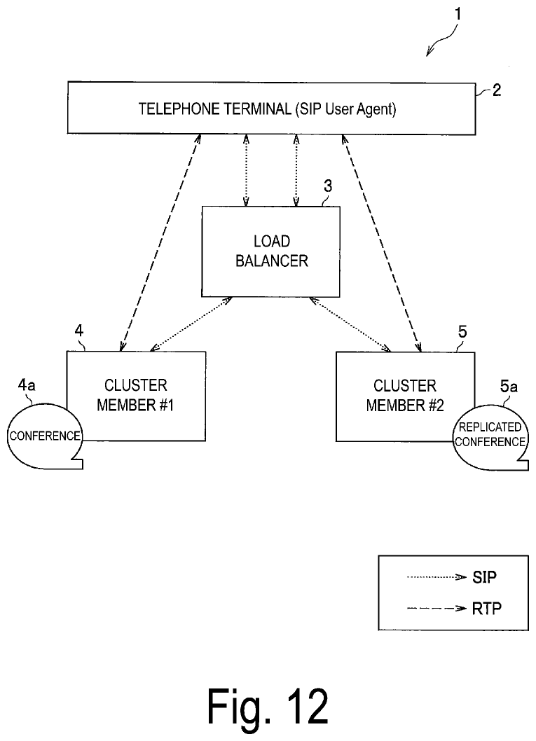

### DESCRIPTION OF EMBODIMENTS

Hereinafter, a server apparatus and the like used in a distributed processing system according to an embodiment for carrying out the present invention (hereinafter, referred to “the present embodiment”) will be described with reference to drawings.

### First Embodiment

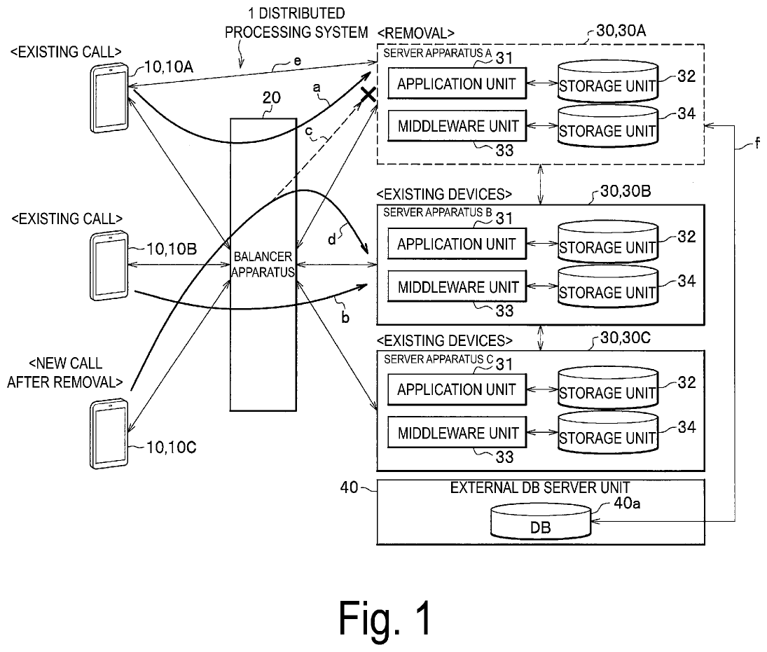

FIG. 1 is a functional block diagram schematically illustrating a distributed processing system according to an embodiment of the present invention.

As illustrated in FIG. 1, a distributed processing system 1 according to the present embodiment of the present invention is a system adapted to perform distributed processing on call signals for establishing sessions among a plurality of user terminal apparatuses 10 (10A, 10B, 10C, . . . ) using a plurality of server apparatuses 30 (30A, 30B, 30C, . . . ) (cluster members). The distributed processing system 1 includes a balancer apparatus 20 communicatively connected to the plurality of user terminal apparatuses 10 and the plurality of server apparatuses 30 communicatively connected to the balancer apparatus 20 and other server apparatuses 30.

Also, an external database server unit 40 adapted to remove server apparatuses 30 as targets of removal in response to a removal instruction from the distributed processing system 1 is placed outside the distributed processing system 1.

Balancer Apparatus

The balancer apparatus 20 is a so-called load balancer (LB) adapted to receive call signals transmitted by the user terminal apparatuses 10 and transmit the received call signals to any of the plurality of server apparatuses 30 in accordance with a simple rule.

Server Apparatus

Each server apparatus (virtual machine (VM) 30 receives call signals transmitted by the user terminal apparatuses 10 via the balancer apparatus 20 and calculates hash values by hashing the received call signals. Further, the server apparatus dispatches (transfers) the call signals to any of the plurality of server apparatuses 30 (that is, the server apparatuses 30 that have already been provided in the distributed processing system 1) including the server apparatus 30, based on the calculated hash values. The server apparatus 30 is configured of a central processing unit (CPU), a read-only memory (ROM), a random access memory (RAM), an input/output circuit, and the like, and includes, as functional units, an application unit 31, a storage unit 32 for the application unit 31, a middleware unit 33, and a storage unit 34 (storage section) for the middleware unit 33. Note that as the server apparatuses 30 include session initiation protocol (SIP) servers adapted to process calls and a web server, for example, adapted to perform processing other than processing of calls.

Application Unit

The application unit 31 is a functional unit adapted to execute functions of an application in the CPU of each server apparatus 30. The application unit 31 causes the storage unit 32 to store information regarding call signals. The application unit 31 performs session control using call signals dispatched to the server apparatus 30 by the middleware unit 33, which will be described later, based on the information regarding call signals stored in the storage unit 32.

Middleware Unit

The middleware unit 33 is a functional unit adapted to execute functions of middleware in the CPU of each server apparatus 30. The middleware unit 33 causes application processing at a transfer source to be continued until a completion notification of takeover processing of the middleware from the transfer source to the transfer destination is received (which will be described later in detail). The middleware unit 33 calculates hash values by hashing user terminal apparatus IDs included in the call signals acquired by the server apparatus 30. Further, the middleware unit 33 dispatches (transfers) the call signals acquired by the server apparatus 30 to any of the plurality of server apparatuses 30 including the server apparatus 30 based on the calculated hash values and a preset dispatch rule.

The telephone terminals (user terminal apparatus) 10 perform interactions with the server apparatuses 30 (cluster members) using the SIP via the balancer apparatus 20 (see the reference signs a to d in FIG. 1). The telephone terminals 10 and the server apparatuses 30 (cluster members) perform interactions directly with each other using the RTP without the balancer apparatus 20 interposed therebetween (see the reference sign e in FIG. 1). Also, the server apparatuses 30 (cluster members) and the external database server unit 40 perform interactions directly with each other using the RTP without the balancer apparatus 20 interposed therebetween (see the reference sign fin FIG. 1).

In the present embodiment, a “call” will be exemplified as existing processing. Thus, an existing processing ID stored in an existing processing ID database 34a is a user terminal apparatus ID included in a call signal of an existing call, the session of which has already been established until a current timing, that is, a call ID. In the example illustrated in FIG. 1, the server apparatus 30 as a target of removal is a removal target server apparatus 30A. The present embodiment will be described on the assumption that the server apparatus 30 as a target of removal is the removal target server apparatus 30A.

Detailed Functions of Cluster Members

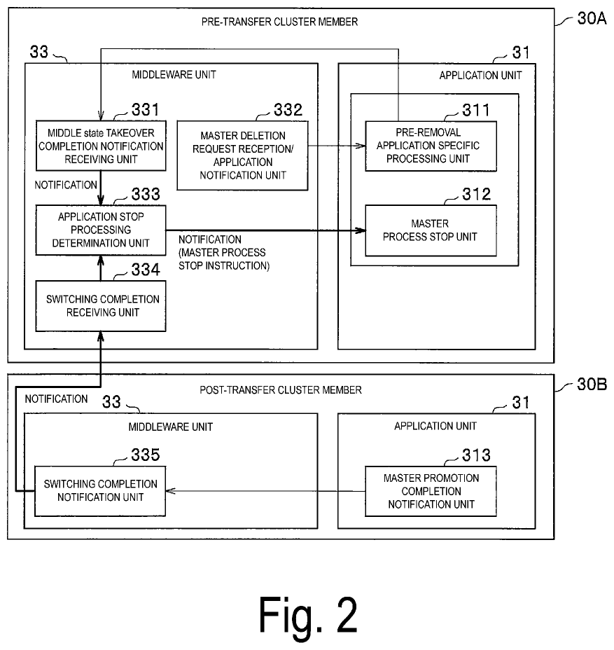

FIG. 2 is a functional block diagram of application units 31 and middleware units 33 of a pre-transfer cluster member and a post-transfer cluster member.

Description will be given on the assumption that the pre-transfer server apparatus 30 is a pre-transfer cluster member 30A and the post-transfer server apparatus 30 is a post-transfer cluster member 30B.

As illustrated in FIG. 2, the application unit 31 of the pre-transfer cluster member 30A includes a pre-removal application specific processing unit 311 and a master process stop unit 312.

The pre-transfer cluster member 30A splits application specific processing, which is executed before removal in the related art, into the pre-removal application specific processing unit 311 and the master process stop unit 312.

The pre-removal application specific processing unit 311 performs the application specific processing to be executed before removal.

The master process stop unit 312 stops a master process in response to a notification (master process stop instruction) from an application stop processing determination unit 333 (application stop determination section).

The middleware unit 33 of the pre-transfer cluster member 30A includes a middle state takeover completion notification receiving unit 331, a master deletion request reception/application notification unit 332, an application stop processing determination unit 333, and a switching completion receiving unit 334 (completion notification receiving section).

The middle state takeover completion notification receiving unit 331 receives a middle state takeover completion notification from the pre-removal application specific processing unit 311 and provides a notification to the application stop processing determination unit 333.

The master deletion request reception/application notification unit 332 notifies the master process stop unit 312 of master deletion request reception/application.

The application stop processing determination unit 333 causes application processing at the transfer source to be continued until a completion notification of takeover processing of middleware from the transfer source to the transfer destination is received.

A switching completion receiving unit 334 receives a completion notification of takeover processing of middleware from the transfer source to the transfer destination.

In the post-transfer cluster member 30B, the application unit 31 includes a master promotion completion notification unit 313.

The master promotion completion notification unit 313 notifies a switching completion notification unit 335 of completion of master promotion.

In the post-transfer cluster member 30B, the middleware unit 33 includes a switching completion notification unit 335.

The switching completion notification unit 335 notifies the switching completion receiving unit 334 of completion of takeover processing middleware from the transfer source to the transfer destination.

Note that the application stop processing determination unit 333, the switching completion receiving unit 334, and the switching completion notification unit 335 are functional units added to the related art.

Hereinafter, operations of the distributed processing system 1 configured as described above will be described.

### Operations of Cluster Members

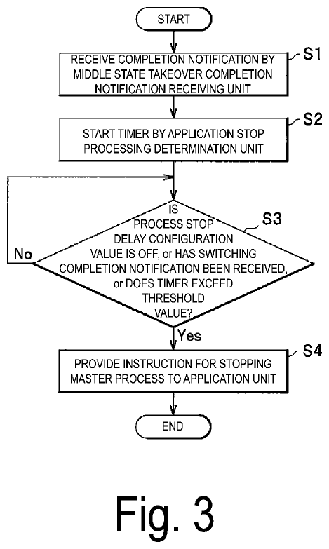

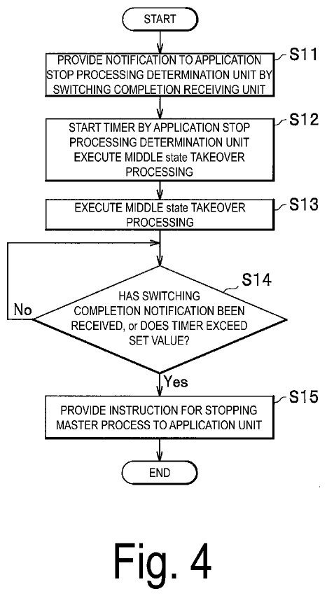

First, an operation example of the middleware unit 33 of each server apparatus 30 (cluster member) will be specifically described with reference to the flows in FIGS. 3 and 4.

### Master Process Stop Delay Determination

FIG. 3 is a flowchart illustrating master process stop delay determination based on a middle state takeover completion notification, which is executed by the middleware unit 33 of the pre-transfer cluster member 30A.

First, in Step S1, the middle state takeover completion notification receiving unit 331 (see FIG. 2) receives a completion notification from the application unit 31 of the pre-transfer cluster member 30A.

In Step S2, the application stop processing determination unit 333 (see FIG. 2) starts time keeping of a timer. The timer is adapted to perform time-out processing in a case in which the completion notification for stopping the application cannot be received for some reason.

In Step S3, the application stop processing determination unit 333 determines whether or not any of a condition that a master process stop delay configuration value is off, a condition that a switching completion notification has been received, and a condition that the timer has exceeded a threshold value is met.

Setting of the aforementioned master process stop delay configuration value will be described.

The aforementioned master process stop delay configuration value is determined and set by a person who is in charge of maintenance in consideration of the following points based on each application property and purposes of utilization.

By turning on the master process stop delay configuration value, in a case in which an application status is changed before switching is completed after the master process is stopped, a change in application status is executed by the pre-transfer cluster member 30A while the change is not taken over to the post-transfer cluster member 30B.

Additionally, this corresponds to a period in which a change in application status is not accepted in the related art.

The setting of the aforementioned master process stop delay configuration value is used for a running form in which a frequency of the change in application status is low.

Returning to the flow in FIG. 3, in accordance with a determination that any of the condition that the master process stop delay configuration value is off, the condition that the switching completion notification has been received, and the condition that the timer has exceeded the threshold value described above in Step S3 is not met (Step S3: No), the processing returns to Step S3 to continue the determination.

In accordance with a determination that any of the aforementioned conditions is met (Step S3: Yes), the application stop processing determination unit 333 notifies the master process stop unit 312 of the pre-transfer cluster member 30A of a master process stop instruction and ends the processing of this flow in Step S4.

### Process Stop Delay Determination

FIG. 4 is a flowchart illustrating a master process stop delay determination based on a switching completion notification, which is executed by the middleware unit 33 of the pre-transfer cluster member 30A.

In Step S11, the switching completion receiving unit 334 (see FIG. 2) notifies the application stop processing determination unit 333 of completion of switching.

In Step S12, the application stop processing determination unit 333 (see FIG. 2) starts time keeping of the timer.

In Step S13, the application stop processing determination unit 333 executes middle state takeover processing.

In Step S14, the application stop processing determination unit 333 receives a switching completion notification from the switching completion notification unit 335 (see FIG. 2) of the middleware unit 33 of the post-transfer cluster member 30B or determines whether or not the aforementioned timer has exceeded a set value.

In accordance with a determination that both the condition that the aforementioned switching completion notification has been received and the condition that the aforementioned timer has exceeded the set value are not met (Step S14: No), the processing returns to Step S14 to continue the determination.

In accordance with a determination that the aforementioned switching completion notification has been received or the aforementioned timer has exceeded the set value (Step S14: Yes), the application stop processing determination unit 333 notifies the master process stop unit 312 of the pre-transfer cluster member 30A of a master process stop instruction and ends the processing of this flow in Step S15.

Operations of Distributed Processing System Next, operations of the distributed processing system 1 will be described.

### Comparative Example

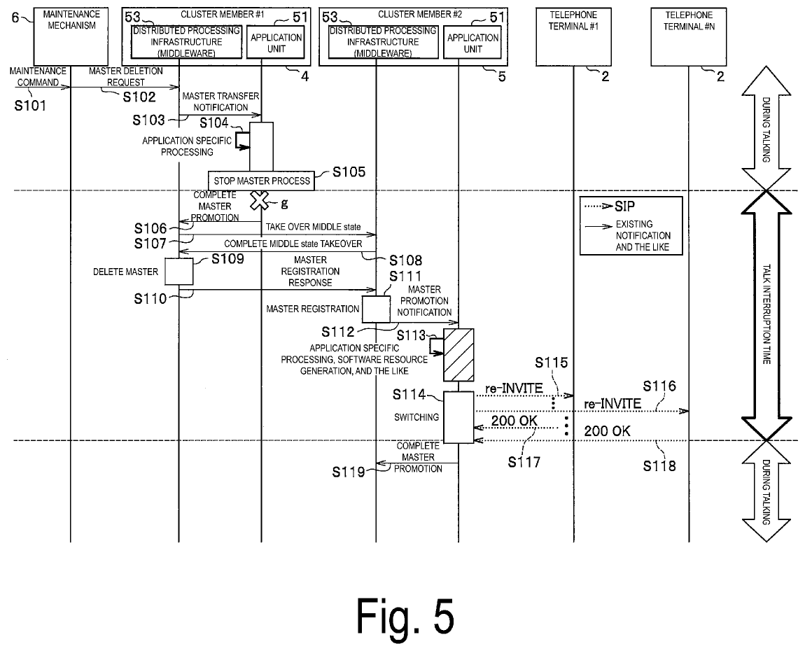

FIG. 5 is a control sequence diagram illustrating operations in a distributed processing system according to a comparative example, which is performed when a maintenance command is input. Note that a “call” is exemplified as application processing.

In the comparative example in FIG. 5, the cluster member #1 is a pre-transfer cluster member while the cluster member #2 is a post-transfer cluster member. A middleware unit 53 of the cluster member #1 in FIG. 5 is a functional unit in the related art which is obtained by eliminating the application stop processing determination unit 333, the switching completion receiving unit 334, and the switching completion notification unit 335 from the middleware unit 33 in FIG. 2. Also, an application unit 51 of the cluster member #1 in FIG. 5 is obtained by eliminating the pre-removal application specific processing unit 311 and the master process stop unit 312 from the application unit 31 in FIG. 2.

During Talking

As a maintenance mechanism 6, a device or the like adapted to monitor and manage lines and equipment configuring a network, facilities at remote locations, and the like are provided to allow an administrator to perform monitoring, running, maintenance, and the like.

As illustrated in FIG. 5, the administrator inputs a maintenance command to the maintenance mechanism 6 (Step S101). The maintenance mechanism 6 receives this maintenance command and requests the middleware unit 53 of the pre-transfer cluster member #1 for deletion of a master (Step S102).

The middleware unit 53 of the pre-transfer cluster member #1 notifies the application unit 51 of the pre-transfer cluster member #1 of transfer of the master (Step S103).

The application unit 51 receives the “master transfer notification” and executes application specific processing (Step S104). Note that outlined blocks in FIG. 5 represent processing continuation periods (the same expression applies to the following drawings).

“Stop master process” is achieved through the application specific processing (Step S105), and the talk is interrupted (see the mark g in FIG. 5). Thereafter, a time until dispatch of the “call” is completed (Step S118, which will be described later) will be defined as a talk interruption time.

Talk Interruption Time

The application unit 51 of the pre-transfer cluster member #1 transmits “master promotion completion” to the middleware unit 53 of the pre-transfer cluster member #1 (Step S106).

The middleware unit 53 of the pre-transfer cluster member #1 receives the “master promotion completion” and transmits “middle state takeover” to the middleware unit 53 of the post-transfer cluster member #2 (Step S107).

The middleware unit 53 of the post-transfer cluster member #2 replies “middle state takeover completion” to the middleware unit 53 of the pre-transfer cluster member #1 (Step S108).

The middleware unit 53 of the pre-transfer cluster member #1 receives the “middle state takeover completion” and performs deletion of the master (Step S109).

The middleware unit 53 of the pre-transfer cluster member #1 transmits a “master registration response” to the middleware unit 53 of the post-transfer cluster member #2 (Step S110).

The middleware unit 53 of the post-transfer cluster member #2 performs master registration (Step S111) and transmits a “master promotion notification” to the application unit 51 of the post-transfer cluster member #2 (Step S112).

The application unit 51 of the post-transfer cluster member #2 receives the “master promotion notification” and executes application specific processing, software resource generation, and the like (Step S113).

However, because the state of the application is not taken over in the processing in Step S113, processing such as acquisition of data from a DB at another location (for example, the external database server unit 40 in FIG. 1) occurs. In other words, although the application has a state, the state is not taken over through the distributed processing, and processing such as acquisition of data generated by another section occurs. Note that the hatched block in FIG. 5 represents a processing period that causes a delay time (the same expression applies to the following drawings).

The application unit 51 of the post-transfer cluster member #2 performs switching of the telephone terminal (user terminal apparatus) 2 after the application specific processing and the software resource generation processing end (Step S114). The telephone terminal 2 performs interactions with the post-transfer cluster member #2 via the load balancer 3 (see FIG. 1) using the SIP.

The application unit 51 of the post-transfer cluster member #2 transmits a switching request “re-INVITE” to the telephone terminal #1 (Step S115) and sequentially transmits switching requests “re-INVITE” to the telephone terminals #N (Step S116). The telephone terminal #1 responds with “200 OK” in a case in which talk is available (Step S117), and similarly, the telephone terminal #1 responds with “200 OK” in a case in which talk is available (Step S118).

Dispatch of a “call” in Steps S114 to S118 described above will be described with reference to FIG. 1 described above.

As illustrated in FIG. 1, in the distributed processing system 1, a server apparatus 30A that has already been provided processes an existing call of the user terminal apparatus 10A (see the reference sign a in FIG. 1), and the server apparatus 30B that has already been provided processes an existing call of the user terminal apparatus 10B (see the reference sign b in FIG. 1).

A case in which a new call from the user terminal apparatus 10C occurs after the server apparatus 30A is removed from the distributed processing system 1 will be described as an example.

It is assumed that in the distributed processing system 1, the server apparatus 30A has been removed (hereinafter, referred to as a removal target server apparatus 30A).

In a case in which a new call from the user terminal apparatus 10C occurs in the distributed processing system 1, the new call from the user terminal apparatus 10C is not dispatched to the removal target server apparatus 30A as illustrated by the reference sign c in FIG. 1 (see the dashed line arrow and the x mark). In this case, the new call from the user terminal apparatus 10C is dispatched to, for example, the server apparatus 30B (see the reference sign d in FIG. 1). Returning to the control sequence in FIG. 5, once the dispatch of the “call” ends, the talk is restarted.

During Talking

Once the dispatch of the “call” ends, the application unit 51 of the post-transfer cluster member #2 notifies the middleware unit 53 of the post-transfer cluster member #2 of “master promotion completion” (Step S119).

In this manner, in the comparative example illustrated in FIG. 5, the takeover processing of the middleware from the transfer source to the transfer destination, the initialization processing of the application at the transfer destination, and the processing of switching the service are performed after the application process at the transfer source ends. The service interruption time includes the takeover processing of the middleware, the initialization processing of the application, and the switching processing.

As illustrated in FIG. 5, the talk interruption time is long and this leads to an increase in D plane disconnection time due to a delay of activation of the application in the comparative example.

### Present Embodiment

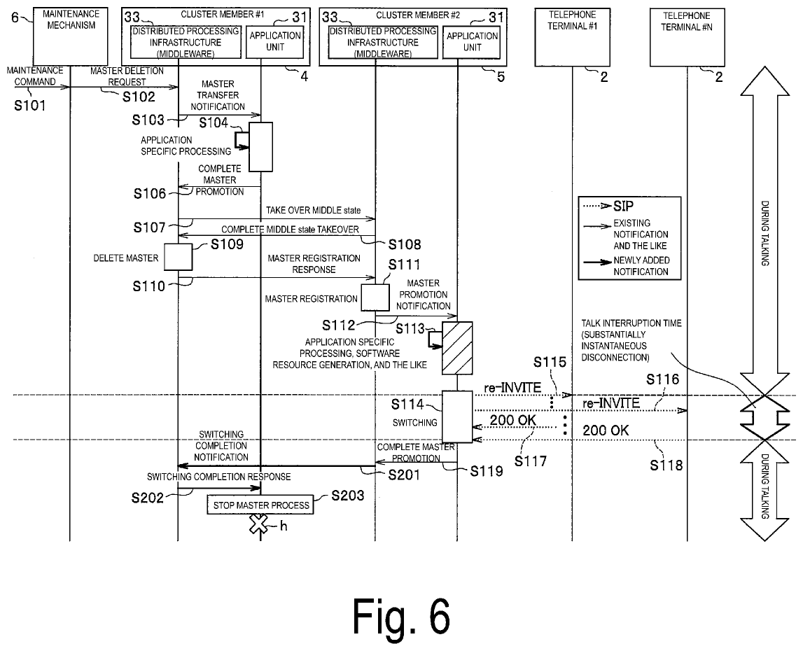

FIG. 6 is a control sequence diagram illustrating operations of the distributed system 1 according to the present invention, which is performed when a maintenance command is input. The same step numbers will be applied to steps in which the same processing as that in the comparative example in FIG. 5 is performed.

During Talking

As illustrated in FIG. 6, the administrator inputs a maintenance command to the maintenance mechanism 6 (Step S101). The maintenance mechanism 6 receives this maintenance command and request the middleware unit 53 of the pre-transfer cluster member #1 for deletion of a master (Step S102).

The middleware unit 53 of the pre-transfer cluster member #1 notifies the application unit 51 of the pre-transfer cluster member #1 of transfer of the master (Step S103).

The application unit 51 receives the “master transfer notification” and executes application specific processing (Step S104).

The master process is stopped through the application specific processing (Step S105), and the talk is interrupted (see the mark g in FIG. 5). Thereafter, a time until “complete master promotion” (Step S118, which will be described later) corresponds to the talk interruption time. In other words, the master process is not stopped.

The application unit 51 of the pre-transfer cluster member #1 transmits “master promotion completion” to the middleware unit 53 of the pre-transfer cluster member #1 (Step S106).

The middleware unit 53 of the pre-transfer cluster member #1 receives the “master promotion completion” and transmits “middle state takeover” to the middleware unit 53 of the post-transfer cluster member #2 (Step S107).

The middleware unit 53 of the post-transfer cluster member #2 replies “middle state takeover completion” to the middleware unit 53 of the pre-transfer cluster member #1 (Step S108).

The middleware unit 53 of the pre-transfer cluster member #1 receives the “middle state takeover completion” and performs deletion of the master (Step S109).

The middleware unit 53 of the pre-transfer cluster member #1 transmits a “master registration response” to the middleware unit 53 of the post-transfer cluster member #2 (Step S110).

The middleware unit 53 of the post-transfer cluster member #2 performs master registration (Step S111) and transmits a “master promotion notification” to the application unit 51 of the post-transfer cluster member #2 (Step S112).

The application unit 51 of the post-transfer cluster member #2 receives the “master promotion notification” and executes application specific processing, software resource generation, and the like (Step S113).

Here, the processing is stopped for the first time. Also, because the D plane performs interactions directly with the telephone, talking can be continued unless the application ends.

Talk Interruption Time Substantially instantaneous disconnection occurs in the talk interruption time, and the D plane disconnection time is significantly short.

The application unit 51 of the post-transfer cluster member #2 performs switching of the telephone terminal (user terminal apparatus) 2 after the application specific processing and the software resource generation processing end (Step S114). The telephone terminal 2 performs interactions with the post-transfer cluster member #2 via the load balancer 3 (see FIG. 1) using the SIP.

The application unit 51 of the post-transfer cluster member #2 transmits a switching request “re-INVITE” to the telephone terminal #1 (Step S115) and sequentially transmits switching requests “re-INVITE” to the telephone terminals #N (Step S116). The telephone terminal #1 responds with “200 OK” in a case in which talk is available (Step S117), and similarly, the telephone terminal #1 responds with “200 OK” in a case in which talk is available (Step S118). Once the dispatch of the “call” ends, the talk is restarted.

During Talking

Once the dispatch of the “call” ends, the application unit 51 of the post-transfer cluster member #2 notifies the middleware unit 53 of the post-transfer cluster member #2 of “master promotion completion” (Step S119).

The middleware unit 53 of the post-transfer cluster member #2 transmits a “switching completion notification” to the middleware unit 53 of the pre-transfer cluster member #1 (Step S201).

The middleware unit 53 of the pre-transfer cluster member #1 transmits a “switching completion response” to the application unit 51 of the post-transfer cluster member #2 (Step S202).

Stop of Master Process

The application unit 51 of the pre-transfer cluster member #1 receives the “switching completion response”, “stop master process” is achieved (Step S203), and the talk is interrupted (see the mark h in FIG. 6).

The master process of the DDC as a target of transfer is stopped after completion of transfer.

As described above, each server apparatus 30 used in the distributed processing system 1 according to the present embodiment includes the switching completion receiving unit 334 adapted to receive a completion notification of takeover processing of middleware from a transfer source to a transfer destination and an application stop processing determination unit 333 adapted to cause application processing at the transfer source to continue until the completion notification is received.

This enables an application end time to be delayed such that the application can be ended before transfer after activation of the application is completed at the transfer destination. It is thus possible for a current processing to be continued without being disconnected in a case in which a server apparatus is removed from the distributed processing system. For example, because the telephone terminal and the server apparatus perform interactions directly with each other in the D plane, talking can be continued unless the application ends. Also, only substantially instantaneous disconnection occurs in a talk interruption time. As a result, it is possible to reduce an increase in D plane disconnection time due to a delay in activation of the application, which is caused because the state of the application is not taken over, in the application of the distributed processing technology for the system in which the C plane and the D plane are integrated.

In this manner, it is possible to reduce a switching time in a case in which such an application that both middleware and the application have states is applied to a distributed processing infrastructure.

### Second Embodiment

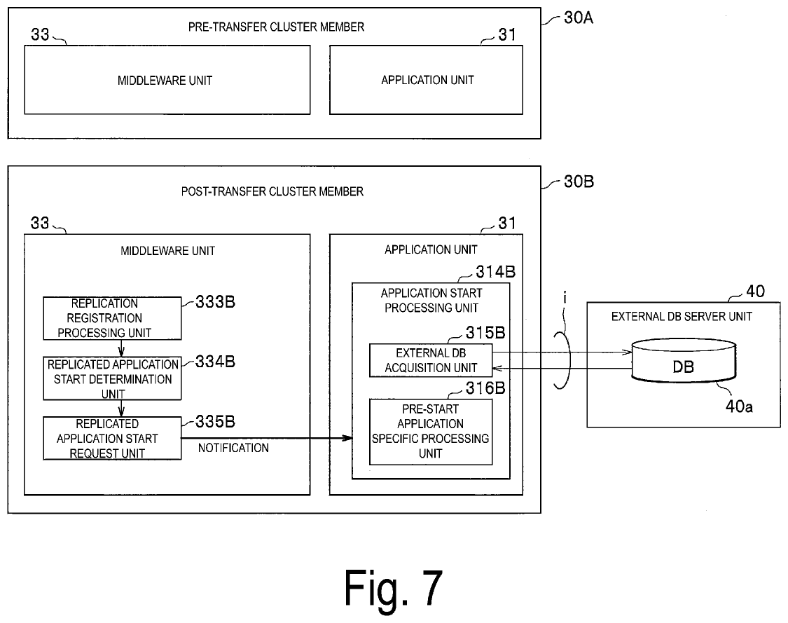

FIG. 7 is a functional block diagram of application units 31 and middleware units 33 of a pre-transfer cluster member and a post-transfer cluster member in a distributed processing system according to a second embodiment of the present invention.

As illustrated in FIG. 7, a post-transfer cluster member 30B of the distributed processing system according to the present embodiment of the present invention is adapted such that the application unit 31 includes an application start processing unit 314B including an external DB acquisition unit 315B and a pre-start application specific processing unit 316B.

The application start processing unit 314B performs application start processing.

The external DB acquisition unit 315B accesses a DB 40a of the external database server unit 40 and acquires data.

The pre-start application specific processing unit 316B performs pre-start application specific processing.

Here, the application specific processing executed before removal is split to a master process stop unit and the other parts.

The middleware unit 33 of the post-transfer cluster member 30B includes a replication registration processing unit 333B, a replicated application start determination unit 334B (application start processing section), and a replicated application start request unit 335B.

The replication registration processing unit 333B performs replication registration processing.

The replicated application start determination unit 334B determines whether to start a replicated application.

The replicated application start request unit 335B requests for a start of the replicated application.

Hereinafter, operations of the distributed processing system configured as described above will be described.

Operations of Cluster Members

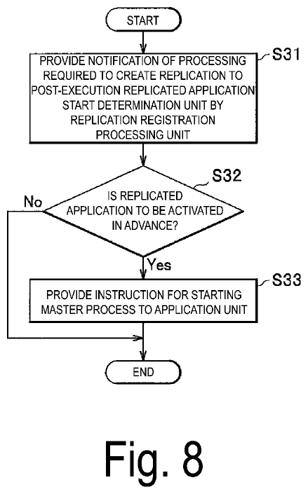

FIG. 8 is a flowchart illustrating a replicated application start determination which is executed by the middleware unit 33 of the post-transfer cluster member 30B.

In Step S31, the replication registration processing unit 333B executes processing required for creating a replication and notifies the replicated application start determination unit 334B of a result of the processing after the execution.

In Step S32, the replicated application start determination unit 334B determines whether or not to activate the replicated application in advance based on a replicated application start determination configuration value set in advance by a person who is in charge of maintenance.

The replicated application start determination configuration setting will be described. The replicated application start determination configuration value sets whether or not to start the replicated application. By turning on the replication ACT, this configuration value is referred to. The replicated application start determination configuration value is determined and set by the person who is in charge of maintenance in consideration of the following matters based on each application property and purposes of utilization.

By turning on the replication ACT, a service interruption time when breakdown occurs is shortened. However, because the application on the side of the replication is also activated by turning on the replication ACT, a load at the time of running increases. In the running form in which it is desired to minimize the service interruption time regardless of an increase in running load, the application is used by turning on the replication ACT.

In accordance with a determination that the replicated application is activated in advance (Step S32: Yes), the replicated application start request unit 335B provides a master process start instruction to the application unit 31 and ends the processing in this flow in Step S33. In accordance with a determination that the replicated application is not activated in advance (Step S32: No), the processing in this flow is just ended.

Operations of Distributed Processing System When Maintenance Command Is Input First, operations of the distributed processing system when a maintenance command is input will be described.

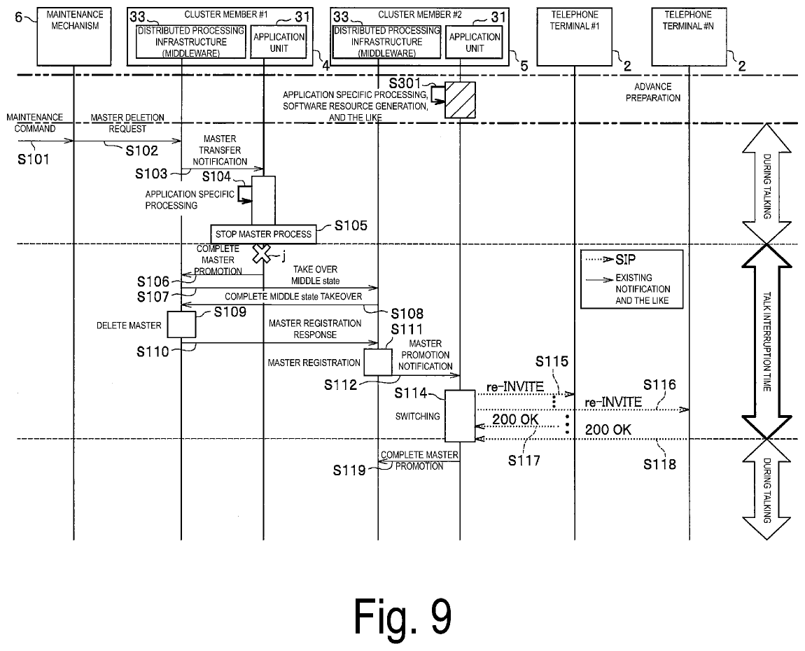

FIG. 9 is a control sequence diagram illustrating operations of the distributed processing system according to the present embodiment performed when a maintenance command is issued. The same step numbers will be applied to steps in which the same processing as that in the comparative example in FIG. 5 is performed.

Advance Preparation

As an assumption, the application at the transfer destination is kept in an active state in advance. In other words, the replication is also brought into an active standby status in advance at the same time with creation of the master.

The application unit 31 of the post-transfer cluster member #2 activates the application in advance in advance preparation and executes application specific processing, software resource generation, and the like (Step S301).

During Talking

The administrator inputs a maintenance command to the maintenance mechanism 6 (Step S101). The maintenance mechanism 6 receives the maintenance command and requests the middleware unit 33 of the pre-transfer cluster member #1 for deletion of the master (Step S102).

The middleware unit 33 of the pre-transfer cluster member #1 notifies the application unit 31 of the pre-transfer cluster member #1 of the transfer of the master (Step S103).

The application unit 31 receives the “master transfer notification” and executes application specific processing (Step S104).

“Stop master process” is achieved through the application specific processing (Step S105), and the talk is interrupted (see the mark j in FIG. 9). Thereafter, a time until dispatch of the “call” is completed (Step S118, which will be described later) will be defined as a talk interruption time.

Talk Interruption Time

The application unit 31 of the pre-transfer cluster member #1 transmits “master promotion completion” to the middleware unit 33 of the pre-transfer cluster member #1 (Step S106).

The middleware unit 33 of the pre-transfer cluster member #1 receives the “master promotion completion” and transmits “middle state takeover” to the middleware unit 33 of the post-transfer cluster member #2 (Step S107).

The middleware unit 33 of the post-transfer cluster member #2 replies “middle state takeover completion” to the middleware unit 33 of the pre-transfer cluster member #1 (Step S108).

The middleware unit 33 of the pre-transfer cluster member #1 receives the “middle state takeover completion” and performs deletion of the master (Step S109).

The middleware unit 33 of the pre-transfer cluster member #1 transmits a “master registration response” to the middleware unit 33 of the post-transfer cluster member #2 (Step S110).

The middleware unit 33 of the post-transfer cluster member #2 performs master registration (Step S111) and transmits a “master promotion notification” to the application unit 31 of the post-transfer cluster member #2 (Step S112).

In the present embodiment, the application as a replication that serves as a transfer destination is activated in advance when the replication is created. In other words, the replication is also brought into an active standby status in advance at the same time with creation of the master. Specifically, the application unit 31 of the post-transfer cluster member #2 activates the application in advance in advance preparation and executes application specific processing, software resource generation, and the like (Step S301). Thus, the application specific processing, the software resource generation, and the like that take time are not executed in the <talk interruption time>.

After the application specific processing and the software resource generation processing end, the application unit 31 of the post-transfer cluster member #2 switches the telephone terminals (user terminal apparatuses) 2 (Step S114). The telephone terminal 2 performs interactions with the post-transfer cluster member #2 via the load balancer 3 (see FIG. 1) using the SIP.

The application unit 31 of the post-transfer cluster member #2 transmits a switching request “re-INVITE” to the telephone terminal #1 (Step S115) and sequentially transmits switching requests “re-INVITE” to the telephone terminals #N (Step S116). The telephone terminal #1 responds with “200 OK” in a case in which talk is available (Step S117), and similarly, the telephone terminal #1 responds with “200 OK” in a case in which talk is available (Step S118). Once the dispatch of the “call” ends, the talk is restarted.

During Talking

Once dispatch of the “call” ends, the application unit 31 of the post-transfer cluster member #2 notifies the middleware unit 33 of the post-transfer cluster member #2 of “master promotion completion” (Step S119).

Operations of Distributed Processing System at Time of Breakdown Next, operations of the distributed processing system at the time of breakdown will be described.

### Comparative Example

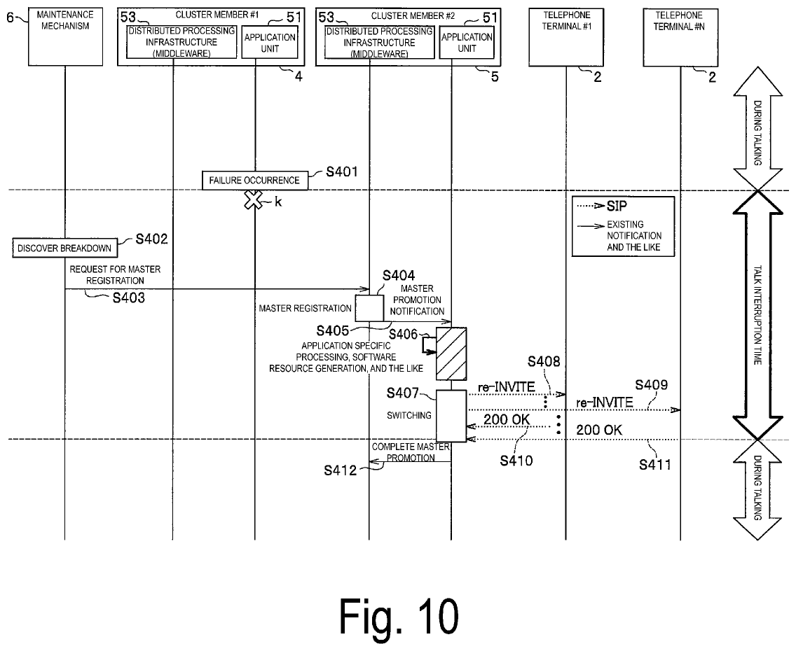

FIG. 10 is a control sequence diagram illustrating operations of a distributed processing system according to a comparative example at the time of breakdown. The same step numbers will be applied to steps in which the same processing as that in the comparative example in FIG. 5 is performed.

During Talking

It is assumed that breakdown has occurred in the application unit 51 of the pre-transfer cluster member #1 during talking (Step S401) (see the mark k in FIG. 10).

Talk Interruption Time

The maintenance mechanism 6 discovers breakdown of a cluster member (here, the pre-transfer cluster member #1) (Step S402).

The maintenance mechanism 6 requests the middleware unit 53 of the post-transfer cluster member #2 for registration of the master (Step S403).

The middleware unit 53 of the post-transfer cluster member #2 receives the master registration request and performs registration of the master (Step S404). The middleware unit 53 of the post-transfer cluster member #2 notifies the application unit 51 of the post-transfer cluster member #2 of promotion of the master (Step S405).

The application unit 51 of the post-transfer cluster member #2 receives the “master promotion notification” and executes application specific processing, software resource generation, and the like (Step S406). As described above, the application specific processing, the software resource generation, and the like take time because processing such as acquisition of data from a DB at a different location (for example, the external database server unit 40 in FIG. 1) occurs.

After the application specific processing and the software resource generation processing end, the application unit 51 of the post-transfer cluster member #2 switches telephone terminals (user terminal apparatuses) 2 (Step S407).

The application unit 51 of the post-transfer cluster member #2 transmits a switching request “re-INVITE” to the telephone terminal #1 (Step S408) and sequentially transmits switching requests “re-INVITE” to the telephone terminals #N (Step S409). The telephone terminal #1 responds with “200 OK” in a case in which talk is available (Step S410), and similarly, the telephone terminal #1 responds with “200 OK” in a case in which talk is available (Step S411).

During Talking

Once the dispatch of the “call” ends, the application unit 51 of the post-transfer cluster member #2 notifies the middleware unit 53 of the post-transfer cluster member #2 of “master promotion completion” (Step S119).

In this manner, initialization processing of the application at the transfer destination and the service switching processing are performed when breakdown is discovered in the comparative example. The service interruption time includes discovery of the breakdown, the application initialization processing, and the switching processing.

In the comparative example, the talk interruption time is long, and the D plane disconnection time due to a delay in activation of the application increases.

### Present Embodiment

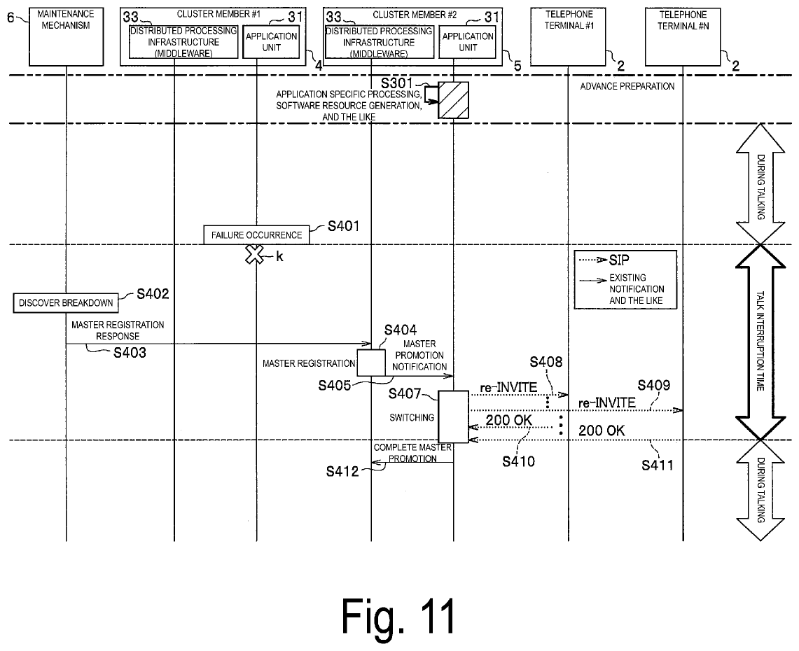

FIG. 11 is a control sequence diagram illustrating operations of the distributed processing system according to the present embodiment at the time of breakdown. The same step numbers will be applied to steps in which the same processing as that in the comparative example in FIG. 10 is performed.

Advance Preparation

The application unit 31 of the post-transfer cluster member #2 activates the application in advance in advance preparation and executes application specific processing, software resource generation, and the like (Step S301). The replication is brought into an active standby status in advance at the same time with the creation of the master.

During Talking

It is assumed that breakdown has occurred in the application unit 51 of the pre-transfer cluster member #1 during talking (Step S401) (see the mark k in FIG. 10).

Talk Interruption Time

The maintenance mechanism 6 discovers breakdown of a cluster member (here, the pre-transfer cluster member #1) (Step S402).

The maintenance mechanism 6 requests the middleware unit 53 of the post-transfer cluster member #2 for registration of the master (Step S403).

The middleware unit 53 of the post-transfer cluster member #2 receives the master registration request and performs registration of the master (Step S404). The middleware unit 53 of the post-transfer cluster member #2 notifies the application unit 51 of the post-transfer cluster member #2 of promotion of the master (Step S405).

After the application specific processing and the software resource generation processing end, the application unit 51 of the post-transfer cluster member #2 switches telephone terminals (user terminal apparatuses) 2 (Step S407).

The application unit 51 of the post-transfer cluster member #2 transmits a switching request “re-INVITE” to the telephone terminal #1 (Step S408) and sequentially transmits switching requests “re-INVITE” to the telephone terminals #N (Step S409). The telephone terminal #1 responds with “200 OK” in a case in which talk is available (Step S410), and similarly, the telephone terminal #1 responds with “200 OK” in a case in which talk is available (Step S411).

During Talking

Once the dispatch of the “call” ends, the application unit 51 of the post-transfer cluster member #2 notifies the middleware unit 53 of the post-transfer cluster member #2 of “master promotion completion” (Step S412).

In this manner, each server apparatus 30 used in the distributed processing system according to the present embodiment activates the application as the replication that serves as the transfer destination in advance when the replication is created. In other words, by bringing the replication into an active standby state in advance at the same time with the creation of the master, it is possible to prevent an increase in switching time due to a delay in activation of the application. It is possible to reduce an increase in a D plane disconnection time due to a delay in activation of the application, which is caused because the state of the application is not taken over, in an application of the distributed processing technology for the system in which the C plane and the D plane are integrated.

It is also possible to reduce a switching time at the time of breakdown as well.

Hitherto, the embodiment of the present disclosure has been described. However, the present disclosure is not limited to the above embodiment, and can be appropriately changed in a range without departing from the gist of the present disclosure.

In addition, among processing described in the embodiments, all or some of processes described as being performed automatically can be manually performed, or all or some of processes described as being performed manually can be performed automatically by well-known methods. In addition, information including the processing procedures, the control procedures, the specific names, and the various types of data, and various parameters described in the aforementioned document and drawings can be modified as desired except in the case specifically noted.

Each component of each apparatus illustrated is a functional concept, and does not necessarily need to be physically configured as illustrated. That is, the specific form of distribution and integration of the apparatus is not limited to the illustrated form, and the entirety or a portion of the form can be configured by being functionally or physically distributed and integrated in any unit, depending on various loads, usage conditions, and the like.

Some or all of the configurations, the functions, the processing units, the processing mechanisms, and the like may be realized in hardware by being designed, for example, in an integrated circuit. Each of the configurations, the functions, and the like may be realized in software for a processor to interpret and execute a program that implements the functions.

Information such as programs, tables, files, and the like, which are for implementing the functions can be held in a recording device such as a memory, a hard disk, and a Solid State Drive (SSD), or a recording medium such as an Integrated Circuit (IC) card, a Secure Digital (SD) card, and an optical disk. In the present specification, the processes describing the time sequential processes include parallel or individually performed processes (for example, parallel processing or object processing) without necessarily being processed sequentially, in addition to processing performed sequentially in described order.

### REFERENCE SIGNS LIST

1 Distributed processing system
10, 10A, 10B, 10C User terminal apparatus
20 Balancer apparatus
30, 30A, 30B, 30C Server apparatus
31 Application unit
33 Middleware unit
311 Pre-removal application specific processing unit
312 Master process stop unit
333 Application stop processing determination unit (application stop determination section)
334 Switching completion receiving unit (completion notification receiving section)
315B External DB acquisition unit
316B Pre-start application specific processing unit
314 Application start processing unit
333B Replication registration processing unit
334B Replicated application start determination unit (application start processing section)
335B Replicated application start request unit

1. A server apparatus used in a distributed processing system configured to:
create processing status data of middleware held by the server apparatus as a replication in another server apparatus, wherein:
the replication is promoted to a master when removal of the server apparatus is carried out, and processing is dispatched to the other server apparatus, thereby continuing processing of the middleware and an application, the server apparatus comprising:
a completion notification receiving section configured to receive a completion notification of takeover processing to the other server apparatus of the middleware; and
an application stop determination section configured to cause the application processing of the server apparatus to be continued until the completion notification is received.

2. The server apparatus according to claim 1, wherein the application stop determination section ends an application process of the server apparatus after the takeover processing of the middleware and processing of initializing the application at a transfer destination.

3. The server apparatus according to claim 1, further comprising:
an application start processing section adapted to bring the application at a transfer destination into an active standby status in which the application is activated in advance when the replication of the middleware is created.

4. The server apparatus according to claim 3, wherein the application start processing section performs the takeover processing to the other server apparatus of the middleware and processing of switching a service after an application process of the server apparatus ends.

5. A distributed processing method performed by a server apparatus used in a distributed processing system configured to:
create processing status data of middleware held by the server apparatus as a replication in another server apparatus, wherein:
the replication is promoted to a master when removal of the server apparatus is carried out, and processing is dispatched to the other server apparatus, thereby continuing processing of the middleware and an application, the method comprising, at the server apparatus:
receiving a completion notification of takeover processing to the other server apparatus of the middleware; and
causing the application processing of the server apparatus to be continued until the completion notification is received.

6. The distributed processing method according to claim 5, further comprising, at the server apparatus:
bringing the application at a transfer destination to be in an active standby status in which the application is activated in advance when the replication of the middleware is created.

7. A program that causes a computer, which serves as a server apparatus used in a distributed processing system configured to:
create processing status data of middleware held by the server apparatus as a replication in another server apparatus, wherein:
the replication is promoted to a master when removal of the server apparatus is carried out, and processing is dispatched to the other server apparatus, thereby continuing processing of the middleware and an application, wherein the program causes the computer to function as:
a completion notification receiving section configured to receive a completion notification of takeover processing to the other server apparatus of the middleware; and
an application stop determination section configured to cause the application processing of the server apparatus to be continued until the completion notification is received.

8. The program of claim 7, wherein the program causes the computer to function as:
an application start processing section adapted to bring the application at a transfer destination into an active standby status in which the application is activated in advance when the replication of the middleware is created.
